(19) United States
(12) Patent Application Publication
(10) Pub. No.: US 2004/0249898 A1
(43) Pub. Date: Dec. 9, 2004

(54) Communication terminal apparatus capable of accessing e-mail from multiple networks at variable intervals

(76) Inventor: Yasunori Tsukioka, Atsugi-shi (JP)

Correspondence Address: COOPER & DUNHAM, LLP, 1185 AVENUE OF THE AMERICAS, NEW YORK, NY, 10036

(21) Appl. No.: 10/890,943

(22) Filed: Jul. 14, 2004

Related U.S. Application Data
(63) Continuation of application No. 09/422,675, filed on Oct. 21, 1999.

(30) Foreign Application Priority Data
Oct. 21, 1998 (JP) 10-299949

(51) Int. Cl. G06F 15/16

(52) U.S. Cl. 709/206

(57) ABSTRACT

A communication terminal apparatus includes a plurality of electronic mail receiving systems respectively receiving electronic mail from mail servers each connected to a different network and an electronic mail receiving interval setting system for setting electronic mail receiving intervals each indicating respective time intervals for accessing electronic mail from the respective networks, each electronic mail receiving interval capable of being set to different values depending on the type of network.

### BACKGROUND OF THE INVENTION

1. Field of the Invention

The present invention relates to a communication terminal apparatus and, more particularly, to a facsimile device provided with electronic mail transmitting/receiving functions.

2. Discussion of the Background Art

A communication terminal apparatus is available which includes a function for automatically receiving electronic mail and is provided with a changing function for changing the electronic mail receiving interval. For example, such a device is described in Japanese Laid-open Patent Publication No. 10-75260/1998.

In addition, communication terminal apparatuses are available with an electronic mail receiving function for receiving electronic mail from a server on the Internet. Such a device is described in Japanese Laid-open Patent Publication No. 9-245088/1997.

In the communication terminal apparatuses capable of receiving electronic mail as mentioned above, the operation of receiving the electronic mail is performed by accessing the mail server at an appropriate electronic mail receiving interval which can be set. When the communication terminal apparatus is provided with an electronic mail receiving function, an electronic mail receiving interval (called “access interval”) is applicable to all such communication terminal apparatuses. Consequently, such apparatuses may not be suitable in all instances because of problems, a few of which will be described below.

For example, a communication terminal apparatus can be equipped with a LAN-I/F or with an ISDN-I/F. If equipped for LAN access, it is not necessary to pay for access to a mail server for each apparatus. On the other hand, if equipped for ISDN access, a fee is inevitably imposed for each access thereto. For the case of PSTN, the situation is the same.

Consequently, when receiving electronic mail by accessing a mail server on the ISDN or PSTN, frequent access to the mail server imposes a communication cost in proportion to the number of access times. This is a problem to be solved.

### SUMMARY OF THE INVENTION

A communication terminal apparatus includes a plurality of electronic mail receiving systems respectively receiving electronic mail from mail servers each connected to a different network and an electronic mail receiving interval setting system for setting electronic mail receiving intervals each indicating respective time intervals for accessing electronic mail from the respective networks, each electronic mail receiving interval capable of being set to different values depending on the type of network. The electronic mail receiving interval setting system may perform operations of interval setting, time setting and manual setting and the electronic mail receiving system may receive the electronic mail from networks such as LAN, ISDN or PSTN.

The communication terminal apparatus may further include a detection system for detecting the existence/non-existence of the respective electronic mail receiving systems, wherein each electronic mail receiving system attempts to access electronic mail at respective time intervals set by the electronic mail receiving interval setting system for each electronic mail receiving system for which a connection is detected by the detection system.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram illustrating the structure of the facsimile device of an embodiment of the present invention;

FIG. 2 is a block diagram illustrating the structure of the network system, to which the facsimile device shown in FIG. 1 is connected.

FIG. 3 is a flowchart illustrating a process at the time of turning on the power source in the facsimile device according to an embodiment of the present invention; and

FIG. 4 is flowchart illustrating the operation of receiving the electronic mail in the facsimile device according to an embodiment of to the present invention.

### DETAILED DESCRIPTION OF THE PREFERRED EMBODIMENT

In describing preferred embodiments of the present invention illustrated in the drawings, specific terminology is employed for the sake of clarity. However, the present invention is not intended to be limited to the specific terminology so selected and it is to be understood that each specific element includes all technical equivalents which operate in a similar manner.

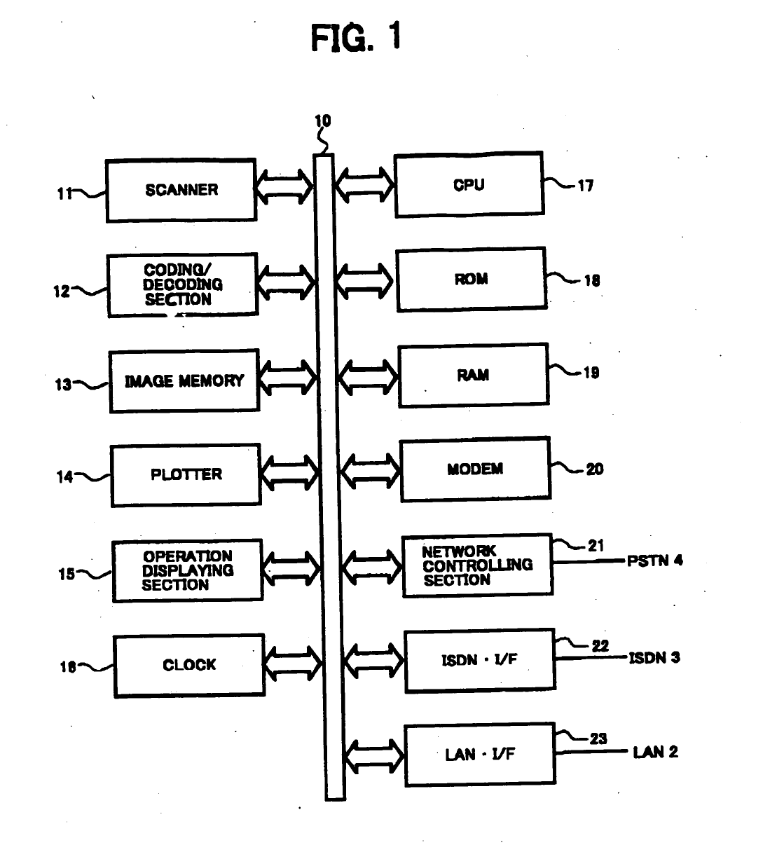

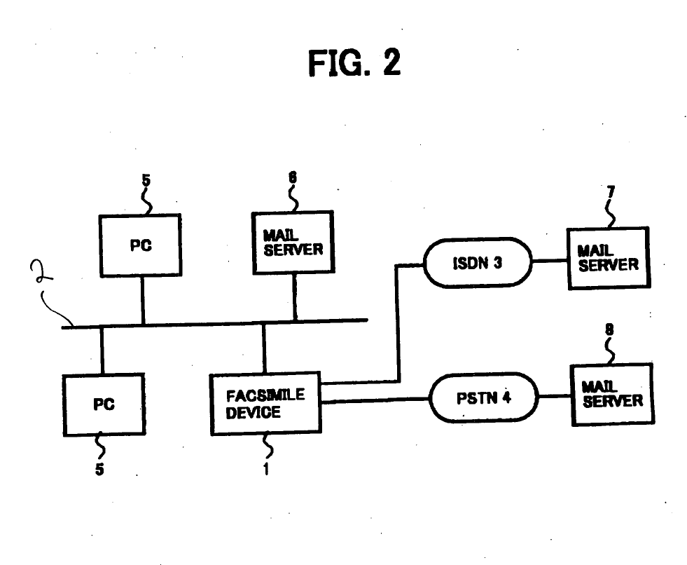

Referring now to the drawings, wherein like reference numerals designate identical or corresponding parts throughout the several views, and more particularly to FIGS. 1 and 2, there are illustrated a facsimile device and a network system, wherein the facsimile device according to an embodiment of the present invention serves as a communication terminal apparatus.

In a first aspect of the present invention, a communication terminal apparatus includes a plurality of electronic mail receiving mediums respectively receiving electronic mail from mail servers each connected to a different network and an electronic mail receiving interval setting system for setting the electronic mail receiving intervals each indicating respective time intervals for accessing electronic mail from the respective networks, each mail receiving interval capable of being set to different values depending on the type of network.

Embodiment

A specific embodiment of the present invention is described hereinafter, referring to the accompanying drawings. FIG. 2 is a block diagram illustrating the structure of the network system, to which a facsimile device of the embodiment serving as the communication terminal apparatus according to the present invention is applied.

The facsimile device 1 is connected to the respective networks LAN 2, ISDN 3, and PSTN 4 so that facsimile device 1 can communicate with each network. Plural terminal apparatuses (PCs) 5 and a mail server 6 are respectively connected to LAN 2. Plural terminal apparatuses (not shown) and a mail server 7 are respectively connected to ISDN 3. Plural terminal apparatuses (not shown) and a mail server 8 are respectively connected to PSTN 4.

The facsimile device 1 can perform operations of facsimile transmitting/receiving for the personal computer (PC) using a G4/G3 protocol, for example. The facsimile device 1 can further perform operations of transmitting/receiving electronic mail to/from the respective mail servers 6, 7 and 8 using a TCP/IP protocol.

FIG. 1 is a block diagram illustrating the structure of the facsimile device 1 according to an embodiment of the present invention.

The facsimile device 1 is connected to a scanner 11, a coding/decoding section 12, an image memory 13, a plotter 14, an operation displaying section 15, a clock 16, a CPU 17, a ROM 18, a RAM 19, a Modem 20, a network controlling section 21, an ISDN-I/F 22, and a LAN-I/F 23 through a CPU bus 10.

The scanner 11 is an image reading-out apparatus for optically reading out the image on a document and inputting the read-out data as image data.

The coding/decoding section 12 performs coding/decoding processing of the image data. The image memory 13 is a memory for storing the image data at the time of transmitting and receiving by the facsimile device 1. The plotter 14 is a printing apparatus such as a laser printer for printing out the image data and the electronic mail.

The operation displaying section 15 includes an inputting apparatus such as a key board, etc. for inputting various commands for performing operations in connection with facsimile transmitting/receiving and electronic mail transmitting/receiving. Section 15 also includes a LCD displaying section for displaying various sorts of guidance in connection with the facsimile transmitting/receiving and the electronic mail transmitting/receiving. The operation displaying section 15 further performs the operation of setting the electronic mail receiving interval, etc. The clock 16 counts the time and the time period used for the respective operations on the facsimile device 1.

The CPU 17 is realized by a microcomputer and together with the ROM 18 and the RAM 19 performs processing operations for controlling the entire facsimile device 1. The CPU 17 further performs operations for setting an electronic mail receiving interval and accessing the mail servers, etc. The ROM 18 is a memory for storing the control programs for performing various types of operations.

The RAM 19 is a memory for storing the various sorts of data referred to by the CPU 17. Information regarding the existence/non-existence of installation of the network controlling section 21, the ISDN-I/F 22, and the LAN-I/F 23 and the mail receiving interval corresponding thereto are stored in a SRAM area in the RAM 19.

TABLE 1, shown below, depicts an example of the format of a mail receiving interval table which stores time interval values for accessing and receiving the respective mails from each of the PSTN, ISDN, and LAN. For instance, as shown in TABLE 1, the time interval for accessing and receiving the mail from the mail server on the LAN 2 is set to 3 minutes. Accordingly, mail server 6 is accessed once every three minutes. The time intervals for accessing and receiving the mail from the mail servers on the ISDN 3 and the PSTN 4 are set to 1 hour, as shown in TABLE 1. Accordingly, mail server 7 and mail server 8 are only accessed once every hour.

TABLE 1
TABLE OF MAIL RECEIVING INTERVALS

| Network | Server | Time Interval |
|---|---|---|
| LAN 2 | LAN mail server 6 | once per three minutes |
| ISDN 3 | ISDN mail server 7 | once per hour |
| PSTN 4 | PSTN mail server 8 | once per hour |

Furthermore, the respective mail server addresses (telephone numbers) of the mail servers 6, 7 and 8 for accessing each of the mail servers through the respective interfaces of the network controlling section 21, ISDN-I/F 22, and LAN-I/F 23 are also stored in the same area of RAM 19.

Each mail server address can be preprogrammed by the user. On this occasion, the address data is inputted using the operation displaying section 15 under the appropriate guidance by the user.

The MODEM 20 performs the operation of modulating and demodulating the data at the time of transmitting/receiving the facsimile data and transmitting/receiving the electronic mail data through the PSTN 4.

The network controlling section 21 is an interface (I/F) which is connected to the PSTN 4 and enables transmitting/receiving of the facsimile data and the electronic mail data through the PSTN 4.

The ISDN-I/F 22 is an interface (I/F) which is connected to the ISDN 3 and enables transmitting/receiving of the facsimile data and the electronic mail data through the ISDN 3.

The LAN-I/F 23 is an interface (I/F) which is connected to the LAN 2 and enables transmitting/receiving of the facsimile data and the electronic mail data through the LAN 2.

That is, the network controlling section 21, ISDN-I/F 22, and LAN-I/F 23 carry out the functions of plural electronic mail receiving systems for respectively receiving the electronic mail from the servers connected to the different networks.

Furthermore, the above-mentioned operation displaying section 15, CPU 17, and RAM 19 carry out the function of an electronic mail receiving interval setting system for setting the mail receiving interval indicating the respective time intervals that each of the above-mentioned respective electronic mail receiving systems will attempt to access and receive electronic mail from the respective networks.

CPU 17 carries out the functions of a detection system for detecting the existence/non-existence of the connection of the above-mentioned respective electronic mail receiving systems.

Furthermore, the CPU 17, clock 16, RAM 19, network controlling section 21, ISDN-I/F 22 and LAN-I/F 23 carry out the functions of a system for accessing and receiving electronic mail at the set intervals for each of the respective electronic mail receiving systems for which a connection thereto is detected by the above-mentioned detection system.

Although this embodiment is applied to a facsimile device, the presently described system can also be applied similarly to other types of communication apparatuses. Furthermore, it may by allowable to simultaneously connect the network controlling section 21, the ISDN-I/F 22, and LAN-I/F 23, or to exclusively (not simultaneously) connect each system.

The respective mail servers 6, 7 and 8 can each be realized, for example, by microcomputer including a CPU, a ROM, and a RAM, etc. Servers 6, 7 and 8 can also execute processing for intermediating the delivery of electronic mail on the respective networks. That is, the respective mail servers 6, 7 and 8 further execute steps for storing electronic mail addressed to the facsimile device 1 and for transferring the electronic mail to the facsimile device 1 at the times they are accessed.

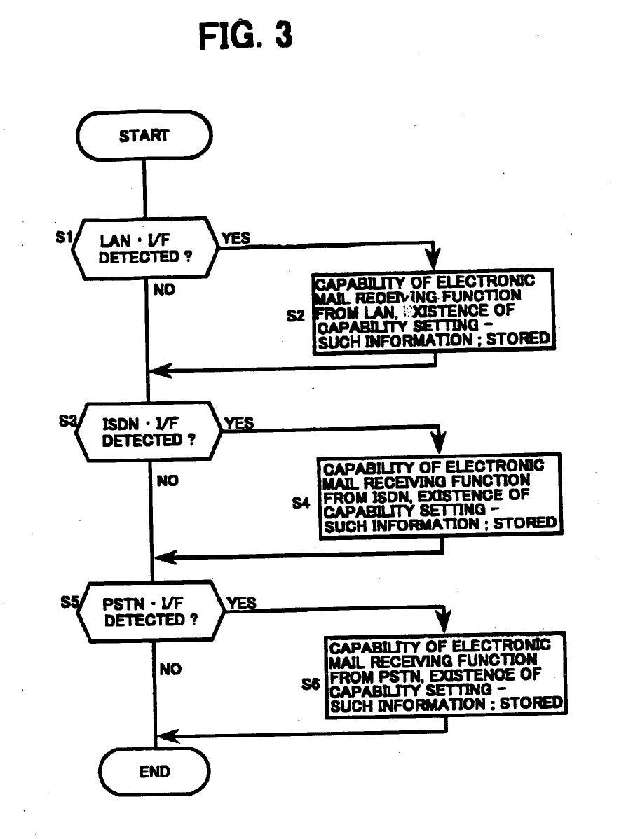

FIG. 3 is a flowchart illustrating a process performed at the time of turning on the power source in the facsimile device 1 according to an embodiment of the present invention.

When the power source is turned on, the CPU 17 detects whether the LAN-I/F 23 is connected in step S1. When the connection thereof is not detected (No, step S1), the process advances to step S3. On the other hand, when the connection of the LAN-I/F 23 is detected, the process advances to step S2, and setting information indicating the existence of an electronic mail receiving function from the LAN 2 is stored in the SRAM area of the RAM 19. The process then further advances to step S3.

In step S3, the CPU 17 judges whether the ISDN-I/F 22 is connected. When the connection thereof is not detected (No, step S3), the process advances to step S5. On the other hand, when the connection thereof is detected (Yes, step S3), the process advances to step S4, and setting information indicating the existence of the electronic mail receiving function from the ISDN 3 is stored in the SRAM area of the RAM 19, and then the process further advances to step S5.

In step S5, the CPU 17 judges whether the PSTN-I/F (e.g., the network control section 21) is connected in step S5. When the connection thereof is not detected (No, step S5), the process is completed. On the other hand, when the connection thereof is detected (Yes, step S5), the process advances to step S6, and setting information indicating the existence of the electronic mail receiving function from the PSTN 4 is stored in the SRAM area of the RAM 19, and then the process is completed.

In such way, the existence or non-existence of the mail receiving functions by each of the respective interfaces can be checked in order.

The respective interfaces themselves may each be provided as standard on some facsimile devices. On the other hand, the respective interfaces may be supplied (provided) as optional cards or boards on other facsimile devices.

When the above-mentioned processes are performed, if the addresses of the mail servers corresponding to the respective interfaces are not preregistered, the partner to be connected cannot be known and thereby the electronic mail cannot be received. On this occasion, even though there exists the required hardware, the CPU 17 will judge that there exists no function for receiving the electronic mail from the particular interface(s).

Although not shown in FIG. 3, addresses of each of the mail servers 6, 7 and 8 are previously set and inputted by the operation displaying section 15 mentioned above. The addresses thus set and inputted are stored in the SRAM area of the RAM 19.

Furthermore, the time interval settings for accessing the mail servers are set from the operation displaying section 15, and when the times are set, or when a manual changing of a setting is performed before performing the above-mentioned process shown in FIG. 3, the CPU 17 stores the set and inputted information in the SRAM area of RAM 19. For example, the mail receiving interval table shown in TABLE 1 is made, and the mail receiving intervals, etc. are stored in the RAM 19. The CPU 17 then refers to the setting contents at the time of the mail server accessing period as will be described below.

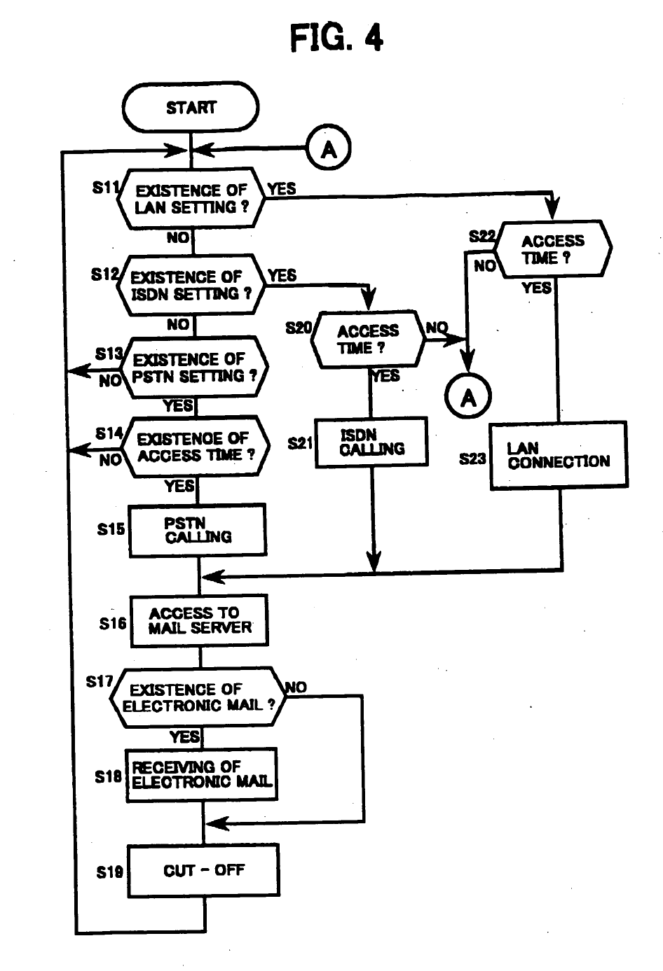

FIG. 4 is a flowchart illustrating the operation for attempting to access mail servers 6-8 for receiving the electronic mail in the facsimile device 1, according to an embodiment of the present invention.

In step S11, the CPU 17 judges whether setting information, indicating the existence of the electronic mail receiving function from the LAN 2, is stored in the SRAM area of RAM 19.

If the LAN setting information exists (Yes, step S11), the process advances to step S22. In step S22, the CPU 17 compares the server accessing period (electronic mail receiving interval stored in RAM 19 in TABLE 1) which is set corresponding to the LAN 2, with the present time information which can be known from the clock 16, and judges whether it is time to access mail server 6 on the LAN 2. That is, the CPU 17 examines the interval value shown in TABLE 1 for the LAN and judges whether three minutes has elapsed since the previous access.

If the time is not the accessing time (No, step S22), the process returns to step S11. If the time is the accessing time (e.g., three minutes has elapsed), the process advances to step 23 and the LAN 2 is connected. The process then advances to step S16, and the mail server 6 on the LAN 2 is accessed. The process then advances to step S17, and the CPU 17 determines whether there exists in mail server 6 electronic mail addressed to facsimile device If there exists electronic mail addressed to facsimile device 1 (Yes, step S17), the process advances to step S18 and the electronic mail is received. The process then advances to step S19, and the connection with the LAN 2 is cut off, and then the process returns back to step S11.

If the setting information, indicating the existence of the electronic mail receiving function from the LAN 2 is not stored in the SRAM area of the RAM 19 (No, step S11), the process advances to step S12, and the CPU 17 judges whether setting information, indicating the existence of the electronic mail receiving function from the ISDN 3, is stored in the SRAM area of the RAM 19 (e.g., whether the setting information for the ISDN exists).

If the ISDN setting information exists (Yes, step S12), the process advances to step S20 and the CPU 17 compares the server accessing period (electronic mail receiving interval stored in RAM 19 in TABLE 1) which is set corresponding to the ISDN 3, with the present time information which can be known from the clock 16, and judges whether it is time to access mail server 7 on the ISDN. That is, CPU 17 examines the interval value shown in the table TABLE 1 for the ISDN 3 and judges whether one hour has elapsed since the previous access.

If the time is not the accessing time (No, step S20), the process returns to step S11. If the time is the accessing time (namely, one hour has elapsed), the process advances to step S21 and the mail server 7 on the ISDN 3 is called. The process advances to step S16 and the mail server 7 on the ISDN 3 is accessed. The process then advances to step S17 and it is determined whether there exists in mail server 7 electronic mail addressed to facsimile device 1.

If there exists electronic mail addressed to facsimile device 1 (Yes, step S17), the process advances to step S18 and the electronic mail is received. The process then advances to step S19 and the connection with the ISDN 2 is cut off. The process then returns to step S11. If there exists no electronic mail addressed to the facsimile device 1 (No, step S17), the process advances to step S19 and the connection with the ISDN 2 is cut off, and the process returns back to step S11.

If the setting information indicating the existence of the electronic mail receiving function from the ISDN 3 is not stored in the SRAM area of the RAM 19 (No, step S12), the process advances to step S13.

In step S13, the CPU 17 judges whether setting information indicating the existence of the electronic mail receiving function from the PSTN 4 is stored in the SRAM area of the RAM 19 (e.g., whether there exists PSTN setting information).

If the PSTN setting information exists (Yes, step S13), the process advances to step S14 and the CPU 17 compares the server accessing period (electronic mail receiving interval stored in RAM 19 in TABLE 1) which is set corresponding to the PSTN 4, with the present time information which can be known from the clock 16, and judges whether it is time to assess mail server 8 on the PSTN 4. That is, CPU 17 examines the interval value shown in TABLE 1 for the PSTN 4 and judges whether one hour has elapsed since the previous access.

If the time is not the accessing time (No, step S14), the process returns to step S11. If the time is the accessing time (e.g., one hour has elapsed), the process advances to step S15 and the mail server 8 on the PSTN 4 is called. The process then advances to step S16 and access to the mail server 8 on the PSTN 4 is performed. The process advances to step S17, and whether there exists in mail server 8 electronic mail addressed to the facsimile device 1 is determined in step S17.

If there exists electronic mail addressed to the facsimile device 1 (Yes, step S17), the process advances to step S18 and the electronic mail is received. The process then advances to step S19 and the connection with the PSTN 4 is cut off. The process then returns to step S11. If there exists no electronic mail addressed to the facsimile device 1, (No, step S17) the process advances to step S19 and the connection with the PSTN is cut off, and then the process returns to step S11.

In such way, if the CPU 17 judges that there exists the function of receiving the electronic mail be use of one or more of the interfaces, the CPU 17 compares the server accessing period which is set for the corresponding interfaces, with the present time information which can be known from the clock 16, and judges whether it is time to access the mail server of the network connected to the particular interface. The CPU 17 accesses the mail server with the above (access) timing and receives any electronic mail addressed to facsimile device 1.

The above-mentioned server accessing periods are preset and the time interval, time and manual changes to these settings can be performed from the operation displaying section 15. The settings thus set and inputted are stored in the SRAM area of the RAM 19 by the CPU 17. Furthermore, it may be allowable to use previously determined values (e.g. default values) when special settings are not required.

For instance, if a access to the mail server can be manually initiated, a “manual plug” can be tuned on. When the above-mentioned server accessing period is checked, the controlling operation for taking care of the manual plug can be performed at the same time for accessing one or more of the mail servers.

When the CPU 17 judges that it is time to access the mail server, the address of the mail server (the telephone number in the case of the ISDN/PSTN) is loaded from the SRAM area of RAM 19, and the mail server is accessed using a method suitable for the respective interface. If there exists electronic mail addressed to the facsimile device 1, that mail is received using a known protocol (e.g., POP).

When the electronic mail has been received, the connections of the respective (telephone) circuits are cut off, and the process returns to the step of checking the time interval.

In such way, since the electronic mail receiving interval can be changed and set for each of the respective electronic mail receiving systems of the LAN, ISDN, and PSTN, a fee is not imposed for access to the mail server, for instance, when the electronic mail from the LAN by the LAN-I/F is received. Therefore, it is possible to pursue real time accessing and receiving of electronic mail by frequently accessing the LAN server.

On the other hand, when the electronic mail is received from the ISDN or PSTN, the ISDN network or the PSTN network is used by accessing the corresponding mail server, and therefore a monetary fee is imposed. In such a situation, when the electronic mail is received by use of the dial-up to the ISDN or PSTN, the condition is set such that the mail servers corresponding thereto are not accessed so frequently when compared with the case of the LAN. As the result, the communication cost can be suppressed.

Furthermore, in addition to an electronic mail receiving system by use of interfaces connected to the different networks, it is also possible to provide an electronic mail receiving system capable of realizing optimum electronic mail receiving capabilities which effectively balances cost and actual efficiency of operation.

Furthermore, since the electronic mail receiving systems employing the interfaces of the respective networks are automatically detected and the electronic mail is received with an electronic mail receiving interval corresponding to the detected interface, even when the electronic mail receiving system is optionally supplied in the form of an optional plug-in card, it is possible to easily recognize the most effective system from among all of the electronic mail receiving systems provided. Consequently, time loss due to manually performing the setting of the electronic mail receiving intervals can be omitted.

Furthermore, when an electronic mail receiving system is changed or added, it is possible to prevent the troublesome matters; such as changing of the electronic mail receiving interval which is valid (effective) until now, forgetting the additional setting and thereby expending unnecessary circuit cost.

Regarding the aforementioned embodiments, a communication terminal apparatus provided with all of the interfaces for the PSTN, ISDN and LAN has been described heretofore. However, it may be preferable to further provide a change-over system for changing over the interface such that the interface selected by a user operation among the above-mentioned respective interfaces can be used.

Furthermore, the above-mentioned interfaces can be embodied in the same way in the selectively provided communication apparatus.

As is apparent from the foregoing description, according to the communication apparatus of the present invention, when the electronic mails are respectively received from the mail servers connected to the different networks, the electronic mails can be received with respective different mail receiving intervals.

The embodiment of the present invention has been described heretofore. However, other numerous embodiments or numerous modifications or variations of the invention are possible in light of the above teaching. It is therefore to be understood that, within the scope of the appended claims, the invention may be practiced otherwise than as specifically described herein.

Having now fully described the invention, it will be apparent to one or ordinary skill in the art that many changes and modifications can be made thereto without departing from the spirit and scope of the invention as set forth herein.

The application is based on Japanese Patent Application No. JPAP10-299,949, filed on Oct. 21, 1998, the entire contents of which are herein incorporated by reference.

1-18. (canceled).

19. A communication terminal apparatus comprising:
a plurality of electronic mail receiving systems respectively receiving electronic mail via a plurality of different networks;
detecting means for detecting network environments available at a present time; and
an electronic mail receiving interval setting system for selecting electronic mail receiving intervals, for accessing electronic mail from the respective networks,
wherein the communication terminal apparatus receives electronic mail at an interval set by the electronic mail receiving interval setting system in accordance with a network environment detected as available by the detecting means.

20. The communication terminal apparatus as claimed in claim 19, wherein said electronic mail receiving interval setting system performs operations of interval setting, time setting and manual setting.

21. The communication terminal apparatus as claimed in claim 19, wherein said electronic mail receiving system receives said electronic mail from at least one of LAN, ISDN and PSTN type networks.

22. The communication terminal apparatus as claimed in claim 19, further comprising:
a detection system for detecting the existence/non-existence of said respective electronic mail receiving systems,
wherein each electronic mail receiving system attempts to access electronic mail at respective time intervals, for each connection detected by the detection system, wherein the intervals were set by said electronic mail receiving interval setting system for each electronic mail receiving system.

23. The communication terminal apparatus as claimed in claim 19, wherein the electronic mail receiving intervals are set by at least one of a user of the apparatus and default values.

24. The communication terminal apparatus as claimed in claim 19, wherein each electronic mail receiving system is provided with a function for registering addresses for a plurality of mail servers and receiving e-mail from each of the plurality of mail servers at a receiving interval set with the electronic mail receiving interval setting system.

25. The communication terminal apparatus as claimed in claim 24, wherein the electronic mail receiving system does not receive e-mail from each of the plurality of mail servers even when a network environment is detected by the detecting means in a case that no mail server is registered.

26. A communication terminal apparatus comprising:
a plurality of electronic mail receiving means for respectively receiving electronic mail via a plurality of different networks;
detecting means for detecting network environments available at a present time; and
electronic mail receiving interval setting means for setting electronic mail receiving intervals for accessing electronic mail from the respective networks,
wherein the communication terminal apparatus receives electronic mail at an interval set by the electronic mail receiving interval setting means in accordance with a network environment detected as available by the detecting means.

27. The communication terminal apparatus as claimed in claim 26, wherein said electronic mail receiving interval setting means performs operations of interval setting, time setting and manual setting.

28. The communication terminal apparatus as claimed in claim 26, wherein said electronic mail receiving means receives said electronic mail from at least one of LAN, ISDN and PSTN type networks.

29. The communication terminal apparatus as claimed in claim 26, further comprising:
detection means for detecting the existence/non-existence of said respective electronic mail receiving means,
wherein each electronic mail receiving means attempts to access electronic mail at respective time intervals, for each connection detected by the detection system, wherein the intervals were set by said electronic mail receiving interval setting means for each electronic mail receiving means.

30. The communication terminal apparatus as claimed in claim 26, wherein the electronic mail receiving intervals are set by at least one of a user of the apparatus and default values.

31. The communication terminal apparatus as claimed in claim 26, wherein each electronic mail receiving means is provided with a function for registering addresses for a plurality of mail servers and receiving e-mail from each of the plurality of mail servers at a receiving interval set with the electronic mail receiving interval setting means.

32. The communication terminal apparatus as claimed in claim 31, wherein the electronic mail receiving means does not receive e-mail from each of the plurality of mail servers even when a network environment is detected by the detecting means in a case that no mail server is registered.

33. A method of communication using a terminal apparatus comprising:
respectively receiving electronic mail via a plurality of different networks, by use of a plurality of electronic mail receiving systems;
detecting network environments available at a present time;
setting electronic mail receiving intervals for accessing electronic mail from the respective networks; and
receiving electronic mail at one of the electronic mail receiving intervals in accordance with a detected network environment.

34. The method of communication using a terminal apparatus as claimed in claim 33, further comprising:
detecting the existence/non-existence of said respective electronic mail receiving systems and
attempting to access said electronic mail at respective time intervals set by said electronic mail receiving interval setting step for each electronic mail receiving system detected in said detecting step.

35. The method of communication using a terminal apparatus as claimed in claim 33, further comprising registering addresses for a plurality of mail servers and receiving e-mail from each of the plurality of mail servers at a corresponding one of the electronic mail receiving intervals.

36. The method of communication using a terminal apparatus as claimed in claim 35, wherein the electronic mail receiving system does not receive e-mail from each of the plurality of mail servers even when a network environment is detected in a case that no mail server is registered.

37. A communication terminal apparatus comprising:
a plurality of electronic mail receiving means for respectively receiving electronic mail via a plurality of different networks, including at least a local area network (LAN) and a public switched telephone network (PSTN) where the electronic mail is received from the LAN via a network interface card and the electronic mail is received from the PSTN in protocol description units;
detecting means for detecting network environments available at a present time; and
electronic mail receiving interval setting means for setting electronic mail receiving intervals for accessing electronic mail from the respective networks,
wherein the communication terminal apparatus receives electronic mail at an interval set by the electronic mail receiving interval setting means in accordance with a network environment detected as available by the detecting means.

38. The communication terminal apparatus as claimed in claim 37, wherein each electronic mail receiving means is provided with a function for registering addresses for a plurality of mail servers and receiving e-mail from each of the plurality of mail servers at a receiving interval set with the electronic mail receiving interval setting means.

39. The communication terminal apparatus as claimed in claim 38, wherein the electronic mail receiving means does not receive e-mail from each of the plurality of mail servers even when a network environment is detected by the detecting means in a case that no mail server is registered.

40. A communication terminal apparatus comprising:
a plurality of electronic mail receiving means for respectively receiving electronic mail via a plurality of different networks, including at least a public switched telephone network (PSTN), a local area network (LAN) and an integrated services digital network (ISDN) where the electronic mail is received from the LAN via a network interface card and the electronic mail is received from the ISDN in interface description units;
detecting means for detecting network environments available at a present time; and
electronic mail receiving interval setting means for setting electronic mail receiving intervals for accessing electronic mail from the respective networks,
wherein the communication terminal apparatus receives electronic mail at an interval set by the electronic mail receiving interval setting means in accordance with a network environment detected as available by the detecting means.

41. The communication terminal apparatus as claimed in claim 40, wherein the electronic mail receiving means is provided with a function for registering addresses for a plurality of mail servers and receiving e-mail from each of the plurality of mail servers at a receiving interval set with the electronic mail receiving interval setting means.

42. The communication terminal apparatus as claimed in claim 41, wherein the electronic mail receiving means does not receive e-mail from each of the plurality of mail servers even when a network environment is detected by the detecting means in a case that no mail server is registered.

43. A method of communication using a terminal apparatus comprising:
respectively receiving electronic mail via a plurality of different networks including at least a public switched telephone network (PSTN) and a local area network (LAN), by use of a plurality of electronic mail receiving systems where the electronic mail is received from the LAN via a network interface card and the electronic mail is received from the PSTN in protocol description units;
detecting network environments available at a present time;
setting electronic mail receiving intervals for accessing electronic mail from the respective networks; and
receiving electronic mail at one of the electronic mail receiving intervals in accordance with a detected network environment.

44. The method of communication using a terminal apparatus as claimed in claim 43, further comprising registering addresses for a plurality of mail servers and receiving e-mail from each of the plurality of mail servers at a corresponding one of the electronic mail receiving intervals.

45. The method of communication using a terminal apparatus as claimed in claim 44, wherein the electronic mail receiving system does not receive e-mail from each of the plurality of mail servers even when a network environment is detected in a case that no mail server is registered.

46. A method of communication using a terminal apparatus comprising:
respectively receiving electronic mail via a plurality of different networks including at least a public switched telephone network (PSTN), a local area network (LAN) and an integrated services digital network (ISDN) wherein the electronic mail is received from the PSTN in protocol description units, the electronic mail is received from the LAN via a network interface card and the electronic mail is received from the ISDN in interface description units, by use of a plurality of electronic mail receiving systems;
detecting network environments available at a present time;
setting electronic mail receiving intervals for accessing electronic mail from the respective networks; and
receiving electronic mail at one of the electronic mail receiving intervals in accordance with a detected network environment.

47. The method of communication using a terminal apparatus as claimed in claim 46, further comprising registering addresses for a plurality of mail servers and receiving e-mail from each of the plurality of mail servers at a corresponding one of the electronic mail receiving intervals.

48. The method of communication using a terminal apparatus as claimed in claim 47, wherein the electronic mail receiving system does not receive e-mail from each of the plurality of mail servers even when a network environment is detected in a case that no mail server is registered.

49. A communications terminal, comprising:
e-mail receiving means for receiving electronic mail via one of plural different network environments;
interval setting means for setting an e-mail receiving interval; and
detecting means for detecting a network environment available at a present time,
wherein the communications terminal receives the electronic mail at the e-mail receiving interval via a network environment detected as available by the detecting means.

50. The communications terminal as claimed in claim 49, wherein the detecting means determines a selected network environment for receiving subsequent e-mail upon detecting available network environments.

51. The communications terminal as claimed in claim 49, wherein the interval setting means sets at least one of a time interval and a designated time.

52. The communications terminal as claimed in claim 49, wherein the different network environments include at least one network environment corresponding to a local area network (LAN).

53. The communications terminal as claimed in claim 49, wherein the interval setting means sets a different access interval for each of the different network environments.

54. The communications terminal as claimed in claim 49, wherein the e-mail receiving means is provided with a function for registering addresses for a plurality of mail servers and receiving e-mail from each of the plurality of mail servers at a receiving interval set with the interval setting means.

55. The communications terminal as claimed in claim 54, wherein the e-mail receiving means does not receive e-mail from each of the plurality of mail servers even when a network environment is detected by the detecting means in a case that no mail server is registered.

56. A communications terminal, comprising:
an e-mail receiving device which receives electronic mail via one of a plurality of different network environments;
an interval setting device which sets an e-mail receiving interval; and
a detecting device which detects a network environment available at a present time,
wherein the communications terminal receives the electronic mail at the e-mail receiving interval via a network environment detected as available by the detecting device.

57. The communications terminal as claimed in claim 56, wherein the detecting device determines a selected network environment for receiving subsequent e-mail upon detecting available network environments.

58. The communications terminal as claimed in claim 56, wherein the interval setting device sets at least one of a time interval and a designated time.

59. The communications terminal as claimed in claim 56, wherein the different network environments include at least one network environment corresponding to a local area network (LAN).

60. The communications terminal as claimed in claim 56, wherein the interval setting device sets a different access interval for each of the different network environments.

61. The communications terminal as claimed in claim 56, wherein the e-mail receiving device is provided with a function for registering addresses for a plurality of mail servers and receiving e-mail from each of the plurality of mail servers at a receiving interval set with the interval setting device.

62. The communications terminal as claimed in claim 61, wherein the e-mail receiving means does not receive e-mail from each of the plurality of mail servers even when a network environment is detected by the detecting device in a case that no mail server is registered.

63. A method of communications using a communications terminal, the method comprising the steps of:
setting an e-mail receiving interval;
detecting a network environment available at a present time from amongst a plurality of different network environments; and
receiving electronic mail at the e-mail receiving interval via one of the plurality of different network environments detected as available by the detecting step.

64. The method as claimed in claim 63, further comprising determining a selected network environment for receiving subsequent e-mail upon detecting the available network environments.

65. The method as claimed in claim 63, further comprising setting at least one of a time interval and a designated time.

66. The method as claimed in claim 63, wherein the different network environments include at least one network environment corresponding to a local area network (LAN).

67. The method as claimed in claim 63, further comprising setting a different access interval for each of the different network environments.

68. The method as claimed in claim 63, further comprising registering addresses for a plurality of mail servers and receiving e-mail from each of the plurality of mail servers at the e-mail receiving interval.

69. The method as claimed in claim 68, wherein the communications terminal does not receive e-mail from each of the plurality of mail servers even when a network environment is detected in a case that no mail server is registered.
